(19) United States
(12) Patent Application Publication
(10) Pub. No.: US 2026/0201912 A1
(43) Pub. Date: Jul. 16, 2026

(54) METHOD FOR THE DETECTION OF A POSITION OF AN ACTUATOR ELEMENT OF A PNEUMATIC ACTUATOR AMID THE USE OF A DETECTION DEVICE, AS WELL AS A SYSTEM OF A PNEUMATIC ACTUATOR AND A DETECTION DEVICE

(71) Applicant: Festo SE & Co. KG, Esslingen (DE)

(72) Inventors: Daniel WALDNER, Nürtingen (DE); Andreas KISCH, Notzingen (DE); Johannes VOLZER, Heroldstatt (DE)

(21) Appl. No.: 19/444,555

(22) Filed: Jan. 9, 2026

(30) Foreign Application Priority Data
Jan. 14, 2025 (DE) 102025101148.6

(51) Int. Cl. F15B 15/28; G01L 19/00

(52) U.S. Cl. CPC F15B 15/2838; G01L 19/0007

(57) ABSTRACT

A method for the detection of a position of an actuator element of a pneumatic actuator amid the use of a detection device with a control unit and with a first pressure sensor. The pneumatic actuator includes a venting device and an actuator housing in which a working recess with a first pressure chamber is formed. The actuator element is received in the working recess and by way of the subjection of the working recess to working fluid is movable in the working recess from a main movement section of the working recess through a first damping section of the working recess which is arranged adjacently to the main movement section, towards a first position, in which the venting device is configured to vent the working recess when the actuator element is situated in the first damping section, and the first pressure sensor is assigned to the first pressure chamber.

### CROSS REFERENCE TO RELATED APPLICATION

This application claims priority to German Patent Application No. 10 2025 101 148.6 filed Jan. 14, 2025, which is incorporated by reference.

### BACKGROUND

The invention relates to a method for the detection of a position of a pneumatic actuator amid the use of a detection device, as well as to a system of a pneumatic actuator and a detection device.

A pneumatic actuator comprise a venting device and an actuator housing, wherein a working recess with a first pressure chamber is formed in the actuator housing, wherein an actuator element is received in the working recess, said actuator element by way of the subjection of the working recess to working fluid being movable in the working recess from a main movement section of the working recess through a first damping section of the working recess which is arranged adjacently to the main movement section, towards a first position, wherein the venting device is configured to vent the working recess when the actuator element is situated in the first damping section.

### SUMMARY

It is the object of the invention to permit a simple, safe and reliable detection of a position of the actuator element.

The method according to the invention for the detection of a position of an actuator element of a pneumatic actuator is carried out amid the use of a detection device with a control unit and with a first pressure sensor, wherein the pneumatic actuator comprises a venting device and an actuator housing in which a working recess with a first pressure chamber is formed, wherein the actuator element is received in the working recess and by way of the subjection of the working recess to working fluid is movable in the working recess from a main movement section of the working recess through a first damping section of the working recess which is arranged adjacently to the main movement section, towards a first position, wherein the venting device is configured to vent the working recess when the actuator element is situated in the first damping section, wherein the first pressure sensor is assigned to the first pressure chamber.

The method according to the invention comprises the following steps: a. providing the pneumatic actuator in the main movement section, b. subjecting the working recess to working fluid, in order to move the actuator element into the first damping section and to vent the working recess, wherein a primary pressure signal is detected by a first pressure sensor during the movement, and c. determining a first primary pressure extreme of the primary pressure signal and/or a second primary pressure extreme of the primary pressure signal by way of the control unit, wherein as a response to the first primary pressure extreme being acquired, it is detected by way of the control unit that the actuator element has entered into the first damping section, and/or wherein as a response to the second primary pressure extreme being acquired, it is detected by way of the control unit that the actuator element has reached the first position.

A position of the actuator element can be detected by way of the method. Herein, it is rendered possible to detect that the actuator element has reached the first position. The first position in particular in an end position, which is to say a position, coming from which the actuator element cannot be moved further along the movement direction in which it was moved directly before reaching the first position. On account of the reaching of the first position being detectable on the basis of the primary pressure signal, one can forgo respective further sensor devices, in particular position switches such as end position switches. By way of this, the effort for the starting operation and hardware can be reduced. Furthermore, the pneumatic actuator can be constructed in a more compact manner.

Moreover, the geometry of the pneumatic actuator, preferably the geometry of the actuator housing can be designed in a simplified manner due to the aforementioned forgoing of sensor devices. In particular, one can forgo the shoulders and/or grooves which are necessary for the positioning or arrangement of sensor devices and which frequently act for example as edges on which dirt collects. In this manner, one can achieve a so-called clean design with which the pneumatic actuator is simpler to clean, which is particularly advantageous in the field of foodstuffs.

The first pressure sensor is assigned to the first pressure chamber. This means that the first pressure chamber is fluidically connected to the first pressure chamber in a manner such that a change of the primary pressure of the working fluid which is received in the first pressure chamber can be detected by the first pressure sensor. A temporal course of the primary pressure is acquired as a primary pressure signal. The first pressure sensor can output an electrical signal which is dependent on the primary pressure to be detected and which is converted into a corresponding pressure signal, specifically into the primary pressure signal. The working recess is abruptly vented when the actuator element is situated in the first damping section. Given the abrupt venting, the pressure of the working fluid received in the first pressure chamber changes in such an abrupt manner that this pressure change can be detected as a first and/or second primary pressure extreme of the primary pressure signal.

If the first primary pressure extreme and the second primary pressure extreme are determined, then firstly the first primary pressure extreme and subsequently the second primary pressure extreme are determined in accordance with a temporal occurrence of these two extremes.

The pneumatic actuator can be designed in a single-acting or double-acting manner. If the pneumatic actuator is designed in a single-acting manner, the actuator element can only be moved in a single direction by way of the subjection of the working recess to working fluid. In order to set back the actuator element, one can provide for example a suitable spring, by way of which a restoring spring force acts upon the actuator element. If the pneumatic actuator is designed in a double-acting manner, then the actuator element can be moved in a first direction by way of subjecting a first part of the working recess, for example the first pressure chamber to working fluid, and be moved in a second direction which is opposite to the first direction by way of subjecting a second part of the working recess, for example a second pressure chamber to working fluid.

On venting the working recess, a fluidic connection is created between the working recess and an environment which surrounds the working recess, so that working fluid which is present in the working recess exits at least partially out of the working recess into the environment.

Preferably, the pneumatic actuator is designed as a pneumatic cylinder, for example as a single-acting or double-acting pneumatic cylinder. Further preferably, the actuator element is designed as a working piston. Alternatively, the pneumatic actuator can be designed as a pneumatic valve and the actuator element as a valve element.

The subjection of the working recess to working fluid is denoted as pressurising. Preferably, the first pressure chamber is subjected to working fluid, in order to move the actuator element into the first damping section. Further preferably, pressurised air is used as working fluid.

Preferably, the first primary pressure extreme is a minimum and/or the second primary pressure extreme is a minimum. Further preferably, the first primary pressure extreme and the second primary pressure extreme are each a minimum. In particular, the first primary pressure extreme is a local minimum and/or the second primary pressure extreme is a local minimum.

Preferably, the working recess comprises a second pressure chamber which is fluidically separated from the first pressure chamber by way of the actuator element, wherein the detection device comprises a second pressure sensor which is assigned to the second pressure chamber, wherein a secondary pressure signal is detected by the second pressure sensor during the movement of the actuator element, wherein a first secondary pressure extreme of the secondary pressure signal and/or a second secondary pressure extreme of the secondary pressure signal is determined by way of the control unit, wherein as a response to the first secondary pressure extreme being acquired, it is detected by way of the control unit that the actuator element has entered into the first damping section and/or wherein as a response to the second secondary pressure extreme being acquired, it is detected by way of the control unit that the actuator element has reached the first position.

The actuator element fluidically separates the first pressure chamber from the second pressure chamber. For this, suitable seals can be fixed to the actuator element. The second pressure sensor is assigned to the second pressure sensor. This means that the second pressure sensor is fluidically connected to the second pressure chamber in a manner such that a change of the secondary pressure of the working fluid which is received in the second pressure chamber can be detected by the second pressure sensor. A temporal course of the secondary pressure is acquired as a secondary pressure signal. The second pressure sensor can output an electrical signal which is dependent on the secondary pressure which is to be detected and which is then converted into a corresponding pressure signal, specifically into the secondary pressure signal.

Further preferably, when the first pressure chamber is subjected to working fluid, thus is pressurised, the actuator element is moved into the first damping section and the second pressure chamber is vented. Conversely, preferably when the second pressure chamber is subjected to working fluid, is thus pressurised, the actuator element is moved into the second damping section and the first pressure chamber is vented. The primary pressure has a tendency to rise due to the pressurising of the first pressure chamber. Conversely, the secondary pressure has a tendency to rise when the second pressure chamber is pressurised. The primary pressure has a tendency to drop by way of the venting of the first pressure chamber. Conversely, the secondary pressure has a tendency to drop when the second pressure chamber is vented.

If the first pressure chamber is pressurised and the actuator element is situated in the main movement section, then the primary pressure rises, in particular until the actuator element reaches the first damping section. The first pressure chamber can be permanently pressurised during the movement of the actuator element. The pressurisation of the first pressure chamber however can also be interrupted when the actuator element exceeds a certain position. Depending on the control of the pressurisation of the first pressure chamber, the primary pressure can permanently rise, firstly rise and then remain constant after the actuator element has exceeded a certain position, firstly rise and then drop after the actuator element has exceeded a certain position, or firstly drop and then rise, for example rise when the actuator element has reached the first position.

The second pressure chamber is abruptly vented when the actuator element is situated in the first damping section. Given an abrupt venting of the second pressure chamber, the secondary pressure abruptly drops, by which means a resistance which counteracts an expansion of the first pressure chamber reduces, said expansion being created by the pressurising of the first pressure chamber. By way of this, a greater expansion occurs in a pointwise manner, by which means the primary pressure drops in a pointwise manner. This drop is detected as a first primary pressure extreme which is formed as a minimum or as a second primary pressure extreme which is formed as a minimum.

Preferably, the first secondary pressure extreme is a maximum and/or the second secondary pressure extreme is a maximum.

Further preferably, the first secondary pressure extreme and the second secondary pressure extreme are each a maximum. In particular, the first secondary pressure extreme is a local maximum and/or the second secondary pressure extreme is a local maximum.

Preferably, a second damping section is arranged in the working recess adjacently to the main movement section and in a manner lying opposite to the first damping section, wherein the venting device is configured to vent the working recess when the actuator element is situated in the second damping section, wherein the actuator element can be moved from the main movement section through the second damping section towards a second position, wherein the working recess is subjected to working fluid, in order to move the actuator element into the second damping section and to vent the working recess.

If the second pressure chamber is pressurised and the actuator element is situated in the main movement section, the secondary pressure rises until the actuator element reaches the second damping section. The first pressure chamber is abruptly vented when the actuator element is situated in the second damping section. Given an abrupt venting of the first pressure chamber, the primary pressure abruptly drops, by which means a resistance which counteracts an expansion of the second pressure chamber reduces, said expansion being caused by the pressurising of the second pressure chamber. By way of this, a greater expansion occurs in a pointwise manner, by which means the secondary pressure drops in a pointwise manner. This drop is acquired as a first secondary pressure extreme which is formed as a minimum or as a second secondary pressure extreme which is formed as a minimum.

The second position in particular is an end position which is to say a position coming from which the actuator element cannot be moved further along the movement direction in which it was moved directly before the reaching of the second position.

Preferably, the primary pressure signal and/or the secondary pressure signal is detected at a frequency of up to 500 Hz, preferably at a frequency of up to 8,000 Hz, further preferably at a frequency of up to 16,000 Hz. In order to permit this, the respectively used pressure sensor, which is to say the first pressure sensor and/or the second pressure sensor, is configured to output signals with a corresponding frequency and the detection device is configured to receive signals with a corresponding frequency.

Preferably, on detection by way of the control unit that the actuator element has reached the first position, one uses an artificial intelligence model, in particular an artificial neuronal network model. It is possible to recognise patterns by way of the artificial intelligence model, so that in particular the accuracy of the detection that the actuator element has reached the first position or the second position can be improved. Furthermore, even given changed conditions, for example a different feed pressure or operating pressure, a different type of design of the actuator element (changed diameter, changed weight), different feed conduits to the pneumatic actuator, one can reliably detect that the actuator element has reached the first position or the second position by way of the artificial intelligence model.

The artificial neuronal network model is a preferred artificial intelligence model which comprises an input layer, an output layer and one or more hidden intermediate layers which lie between the input layer and the output layer. Each layer, which is to say in each case the input layer, the output layer and the intermediate layer, comprises nodes. Each node is connected to at least one further node of a further layer and has a weighting which is assigned to it and a threshold value which is assigned to it. Starting from a node of the input layer, this node is activated when the output of this node lies above its threshold value. Then, starting from this node, data is sent to a node of a further layer which is connected to the node of the input layer, for example of the intermediate layer.

Preferably, the artificial intelligence model comprises at least one so-called long short-term memory cell, LSTM cell for short, which comprises at least one input gate, at least one forget gate, at least one output gate and an inner cell. The extent to which a new value flows into the inner cell is controlled by the input gate. The extent to which a value remains in the inner cell or is forgotten is controlled by the forget gate. The extent to which the value in the inner cell is use for further computation is controlled by the output gate. Herewith, an LSTM cell permits information to be let through in optional manner.

The system according to the invention comprises a pneumatic actuator and a detection device, wherein the pneumatic actuator comprises a venting device and an actuator housing, wherein a working recess with a first pressure chamber is formed in the actuator housing, wherein an actuator element is received in the working recess and by way of the subjection of the working recess to working fluid is movable in the working recess from a main movement section of the working recess through a first damping section of the working recess which is arranged adjacently to the main movement section, towards a first position, wherein the venting device is configured to vent the working recess when the actuator element is situated in the first damping section, wherein the detection device comprises a control unit and a first pressure sensor, wherein the first pressure sensor is assigned to the first pressure chamber, wherein the system is configured to carry out a method as described above.

Preferably, the venting device comprises a first base ring and a first sliding ring, wherein the first base ring or the first sliding ring is fixed to the actuator element, wherein the first sliding ring can be brought onto the first base ring by way of a first sliding movement which runs along a sliding axis, so that a first sliding surface of the first sliding ring which faces the first base ring at least partly covers a first base surface of the first base ring which faces the fist sliding ring, wherein the first base ring comprises a first base venting section on the first base surface, wherein the first sliding ring comprises a first sliding venting section on the first sliding surface, wherein the first base venting section and/or the first sliding venting section are deepened, wherein when the actuator element is moved into the first damping section, the venting device is moved into a first venting position in which the first base venting section and the first sliding venting section at least partly overlap one another.

The first sliding ring can be brought onto the first base ring in a manner such that as soon as the first base surface and the first sliding surface partly overlap, a further bringing of the first sliding ring onto the first base ring is assisted by way of a continuation of the first sliding movement due to the first sliding surface sliding away on the first base surface. The first base surface herein serves as a plain bearing surface for the first sliding surface, by which means the first base ring serves as a plain bearing for the first sliding ring. The first sliding ring can be removed from the first base ring by way of a movement which is directed opposite to the above movement. Hereby, the first base ring at all events also serves as a plain bearing for the first sliding ring until the first base surface and the first sliding surface once again no longer partly overlap.

Preferably, the first sliding ring and/or the second sliding ring is formed from an elastomer, in particular from a thermoplastic elastomer. For example, the first sliding ring and/or the second sliding ring is formed from a polyurethane, an acrylonitrile butadiene rubber, a fluorinated rubber or ethylene-propylene-diene rubber. Further preferably, the first base ring and/or the second base ring is formed from a metal or a plastic, in particular thermoplastic plastic. For example, the first base ring and/or the second base ring is formed from a polyoxymethylene, a polyphenylene sulphide with a base surface of polytetrafluoroethylene, a bronze alloy or an anodised aluminium. Alternatively, the first base ring and/or the second base ring can be designed of glass for applications in the field of laboratory equipment or filling facilities.

The first sliding movement runs along the sliding axis and thus in a linear manner. Depending on the movement direction, as described above, with the first sliding movement the sliding ring can be brought onto the base ring or removed from this.

In the first venting position, the first base venting section and the first sliding venting section at least partly overlap one another. In the first venting position, a working fluid can herewith pass through via the deepened first base venting section and/or the deepened first sliding venting section. The larger the overlapping surface between the first base venting section and the first sliding venting section, the more working fluid can pass through the venting device in the aforementioned manner. The overlapping surface can be enlarged by way of the first sliding ring being brought further onto the first base ring, so that an overlapping length which is pronounced along the sliding axis is enlarged. The overlapping surface can furthermore be enlarged by way of the deepening of the first base venting section and/or the deepening of the first sliding venting section being enlarged, in particular along the sliding axis.

Preferably, the pneumatic actuator comprises a first end cap which is fixed to the actuator housing at the end side. Further preferably, the component from the group: first base ring, first sliding ring, which is not fixed to the actuator element, is fixed to the first end cap.

Preferably, the movement axis runs parallel to the sliding axis. By way of this, a resistance which is opposite to the sliding movement can be reduced.

Preferably, a second damping section is arranged in the working recess adjacently to the main movement section and in a manner lying opposite to the first damping section, wherein the actuator element can be moved from the main movement section through the second damping section towards a second position, wherein the working recess can be subjected to working fluid in order to move the actuator element into the second damping section and to vent the working recess, wherein the venting device comprises a second base ring and a second sliding ring, wherein the second base ring or the second sliding ring is fixed to the actuator element, wherein the second sliding ring can be brought onto the second base ring by way of a second sliding movement which runs along the sliding axis and is directed oppositely to the first sliding movement, so that a second sliding surface of the second sliding ring which faces the second base ring at least partly covers a second base surface of the second base ring which faces the second sliding ring, wherein the second base ring comprises a second base venting section on the second base surface, wherein the second sliding ring comprises a second sliding venting section on the second sliding surface, wherein the second base venting section and/or the second sliding venting section are deepened, wherein when the actuator element is moved into the second damping section, the venting device is moved into a second venting position in which the second base venting section and the second sliding venting section at least partly overlap one another.

That which has been stated above with regard to the first base ring and the first sliding ring analogously applies to the second base ring and the second sliding ring. Preferably, the first base ring and the second base ring are designed in the same manner. Further preferably, the first sliding ring and the second sliding ring are designed in the same manner.

Preferably, the component from the group: second base ring, second sliding ring, which is fixed to the actuator element, is fixed to a side of the actuator element which lies opposite another side of the actuator element, on which other side the component from the group: first base ring, first sliding ring, is fixed to the actuator element. In particular, the component from the group: first base ring, first sliding ring, which is fixed to the actuator element, projects from the actuator element in a different direction than the component from the group: second base ring, second sliding ring, which is fixed to the actuator element.

Further preferably, the pneumatic actuator comprises a second end cap which is fixed to the actuator housing at the end side. In particular, the second end cap is fixed to an end of the actuator housing which lies opposite another end of the actuator housing, on which other end the first end cap is arranged. Further preferably, the component from the group: second base ring, second sliding ring, which is not fixed to the actuator element, is fixed to the second end cap.

Further preferably, the component which is fixed to the second end cap projects into the first pressure chamber. Further preferably, the component which is fixed to the first end cap projects into the second pressure chamber.

Further preferably, the venting of the first pressure chamber is effected via the second end cap. Further preferably, the venting of the second pressure chamber is effected via the first end cap.

Preferably, the first base ring comprises a radially circumferentially closed first base sealing section on the first base surface and/or the first sliding ring comprises a radially circumferentially closed first sliding sealing section on the first sliding surface. By way of this, one succeeds in working fluid not being able to pass through via the first base venting section and/or the first sliding venting section when the first base ring and the first sliding ring merely overlap in the region of the first base sealing section and/or of the first sliding sealing section. The first base sealing section and/or the first sliding sealing section ensure that when the actuator element is moved in the first damping section, this actuator element is initially braked and the working recess subsequently vented.

The initial braking of the actuator element is achieved by way of a venting of the respective pressure chamber into which the actuator element moves, which is to say of its volume, being reduced, in particular being prevented, due to the movement of the actuator element, on account of the first base sealing section and/or the first sliding sealing section. On account of the reduction or prevention of the venting and the reduction of the volume, the pressure of the working fluid which is received in this pressure chamber is increased, by which means the resistance which is counter to the movement of the actuator element is increased and finally the actuator element is braked. After a continuation of the movement of the actuator element towards a position in which the first base sealing section and/or the first sliding sealing section are no longer aligned to one another in a manner such that a venting of the aforementioned pressure chamber is prevented, this pressure chamber is abruptly vented.

Further preferably, the second base ring comprises a radially circumferentially closed second base sealing section on the second base surface and/or the second sliding ring comprises a radial circumferentially closed second sliding sealing section on the second sliding surface. That which has been stated above with regard to the first base sealing section and the first sliding sealing section applies in the same manner to the second base sealing section and the second sliding sealing section.

Preferably, the detection device is distanced to the pneumatic actuator, preferably at a distance of at least 10 cm, particularly preferably at a distance of at least 100 cm. In particular, the distance lies in the region of 10 cm to 500 cm. The distance in particular relates to a path distance which the working fluid must cover in order to get from the pneumatic actuator to the detection device or vice versa. By way of this, the influence of environmental conditions upon the position detection, such acting directly upon the pneumatic actuator, for example temperature, vibrations, impact loads and/or contamination, can be reduced in comparison to if the position detection were to be realised by way of sensors which are arranged on the pneumatic actuator.

Preferably, the actuator housing comprises an intermediate venting opening which is arranged in the main movement section, wherein the venting device is configured to partially vent the working recess when the actuator element is situated in the region of the intermediate venting opening. By way of this, a detection of a position of the actuator element which lies within the main movement section, thus between both end positions, is possible. Preferably, the respective first base venting section or first sliding venting section of the component from the group: first base ring, first sliding ring, which is fixed to the actuator element, overlaps with the intermediate venting opening. If furthermore a component from the group: second base ring, second sliding ring is fixed to the actuator element, then further preferably the respective second base venting section or the second sliding venting section also overlaps with the intermediate venting section, so that two positions of the actuator element can be detected by way of an intermediate venting opening. The first intermediate venting position is the position in which the first base venting section or the first sliding venting section overlap with the intermediate venting opening and the second intermediate venting position is the position in which the second base venting section or the second sliding venting section overlap with the intermediate venting opening. In particular, one can provide several intermediate venting openings, so that detection is made possible for each position which is assigned to one of these several intermediate venting openings.

Preferably, the system further comprises a valve terminal with several pneumatic valves, wherein the valve terminal in particular comprises the detection device, wherein at least one of the pneumatic valves is assigned to the pneumatic actuator, wherein the first pressure sensor is assigned to the pneumatic valve which is assigned to the pneumatic actuator. The valve terminal is an interconnection of several individual pneumatic valves. The valve terminal comprises a central voltage supply and a central working fluid supply, with which in particular all pneumatic valves of the valve terminal can each be commonly supplied electrically and pneumatically. There exists the possibility of a pneumatic valve being assigned to the first pressure chamber of the pneumatic actuator and another pneumatic valve to the second pressure chamber of the pneumatic actuator. Moreover, there is the possibility of an individual pneumatic valve being assigned to the first pressure chamber as well as to the second pressure chamber, of the pneumatic actuator. Such an individual valve can be designed for example as a 5/3-way valve. Furthermore, there exists the possibility of the valve terminal comprising at least one further pneumatic valve which is assigned to at least one further pneumatic actuator or at least one pressure chamber of the further pneumatic actuator.

### BRIEF DESCRIPTION OF THE DRAWINGS

The invention is hereinafter explained in more detail by way of the accompanying drawings and these are:

FIG. 1 a system of a pneumatic actuator and a detection device in an abstract view,

FIG. 2 the pneumatic actuator which is represented in FIG. 1, in a sectioned view,

FIG. 3 a detail of a venting device which is situated in a first venting position, of the pneumatic actuator which is represented in FIG. 2, in a sectioned view,

FIG. 4 the detail of the venting device which is represented in FIG. 3, outside the first venting position,

FIG. 5 a further detail of the venting device in a second venting position,

FIG. 6 the detail of the venting device which is represented in FIG. 5, outside the second venting position,

FIG. 7 a method, for the detection of a position of the actuator element, according to an embodiment,

FIG. 8 a diagram of pressure signal(s) according to an embodiment,

FIG. 9 an actuator housing of the pneumatic actuator which is represented in FIG. 2, with an intermediate venting opening.

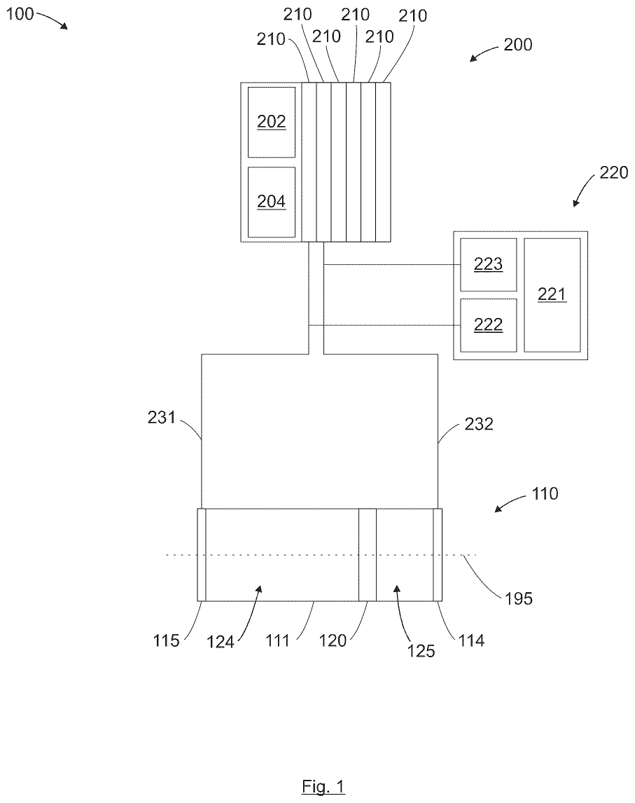

FIG. 1 shows a system 100 of a pneumatic actuator 110 and a detection device 220 in an abstract view. The pneumatic actuator 110 comprises actuator housing 111. Furthermore, the pneumatic actuator comprises a first end cap 114 which is arranged at a first end and a second end cap 115 which is arranged at a second end which is arranged lying opposite to the first end cap 114. The pneumatic actuator 110 comprises a working recess in which an actuator element 120 is movably received. Purely by way of example, the actuator element 120 is movable lineally along a movement axis 195. The actuator element 120 subdivides the working recess into a first pressure chamber 124 and a second pressure chamber 125. Purely by way of example, the first pressure chamber 124 is delimited by the actuator housing 111, the actuator element 120 and the second end cap 115. Further by way of example, the second pressure chamber 125 is delimited by the actuator housing 111, the actuator element 120 and the first end cap 114.

The detection device 220 comprises a first pressure sensor 222, a second pressure sensor 223 and a control unit 221. The first pressure sensor 222 is fluidically connected to the first pressure chamber 124 by way of a first fluid conduit 231, in order to detect a primary pressure of a working fluid which is received in the first pressure chamber 124. Purely by way of example, the fluidic connection between the first pressure chamber 124 and the first pressure sensor 222 runs via the second end cap 115 which is to say that the first fluid conduit 231 is fluidically connected to the second end cap 115. The second pressure sensor 223 is fluidly connected to the second pressure chamber 125 by way of a second fluid conduit 232, in order to detect a secondary pressure of a working fluid which is received in the second pressure chamber 125. Purely by way of example, the fluidic connection between the second pressure chamber 125 and the second pressure sensor 223 runs via the first end cap 114 which into say that the second fluid conduit 232 is fluidically connected to the first end cap 114.

The system 100 further comprises a valve terminal 200 with several pneumatic valves 210. Purely by way of example, the valve terminal 200 comprises six pneumatic valves 210. Purely by way of example, two of the pneumatic valves 210 are assigned to the pneumatic actuator 110. Further by way of example, one of the two pneumatic valves 210 which are assigned to the pneumatic actuator 110 is assigned to the first pressure chamber 124. Further by way of example, another of the two pneumatic valves 210 which are assigned to the pneumatic actuator 110 is assigned to the second pressure chamber 125. The valve terminal 200 comprises a central voltage supply 202 and a central working fluid supply 204 with which in particular all pneumatic valves 210 of the valve terminal 200 are each commonly supplied electrically and pneumatically.

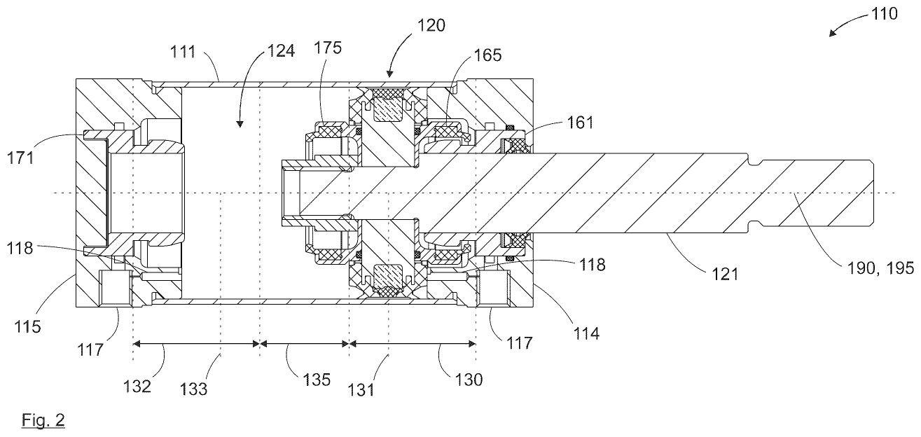

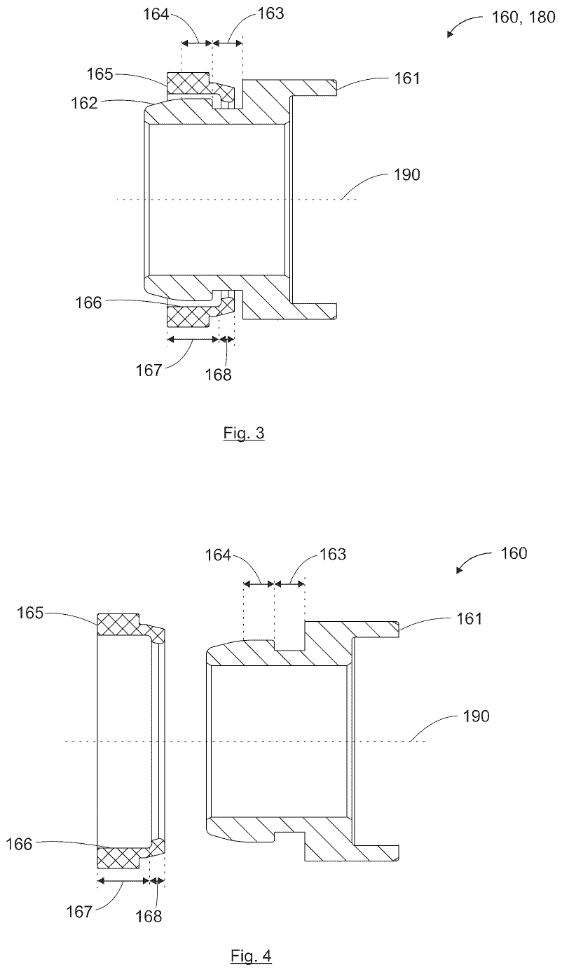

FIG. 2 shows the pneumatic actuator 110 which is represented in FIG. 1, in a sectioned view. The represented section extends along the movement axis 195. The pneumatic actuator 110 comprises a venting device 160 (cf. FIGS. 3 and 4). By way of subjecting the first pressure chamber 124 to working fluid, the actuator element 120 can be moved from a main movement section 135 of the working recess through a first damping section 130 of the working recess which is arranged adjacently to the main movement section 135, towards a first position 131. Purely by way of example, the actuator element 120 is situated in the first position 131 with the configuration which is represented in FIG. 2. The first damping section 130 and herewith the first position 131 purely by way of example are arranged to the right of the main movement section 135, so that the actuator element 120 further by way of example is situated in a right end stop of the pneumatic actuator 110 which corresponds to the first position 131.

In the representation which is shown in FIG. 2, a volume of the second pressure chamber 123 is so low due to the position of the actuator element 120 that the second pressure chamber 125 is no longer visible. By way of subjecting the second pressure chamber 125 (cf. FIG. 1) to working fluid, the actuator element 120 is movable from the main movement section 135 of the working recess through a second damping section 132 of the working recess which is arranged adjacently to the main movement section 135, towards a second position 133. Purely by way of example, the second position 133 corresponds to a left end stop of the pneumatic actuator 110.

The first end cap 114 and the second end cap 115 each comprise a fluid connection 117 via which the respective pressure chamber 124, 125 is fluidically connected to the respective pressure sensor 222, 223 and the respective pneumatic valve 210. A first base ring 161 is fixed to the first end cap 114. A first sliding ring 161 is fixed to the actuator element 120. The first base ring 161 and the first sliding ring 165 are part of the venting device 160 which is represented in FIGS. 3 and 4. The venting device 160 further comprises a second base ring 171 and a second sliding ring 175 which is fixed to the second end cap 115. The second sliding ring 175 is fixed to the actuator element 120. The second base ring 175 and the second sliding ring 175 are also part of the venting device 160, wherein only a detail of the venting device 160 in which the first base ring 161 and the first sliding ring 165 are visible is represented in FIGS. 3 and 4.

The second sliding ring 175 is fixed to a side of the actuator element 120 which lies opposite to another side of the actuator element 120, on which other side the first sliding ring 165 is fixed. The first sliding ring 165 projects from the actuator element 120 in the first movement direction. The second sliding ring 175 projects from the actuator element 120 in the second movement direction.

The pneumatic actuator 110 further comprises a piston rod 121 which is connected to the actuator element 120. Purely by way of example, the actuator element 120 is designed as a working piston. The piston rod 121 can be moved to the same extent by way of movement of the actuator element 120. The piston rod 121 passes through the first end cap 114.

The first sliding ring 165 can be brought onto the first base ring 161 by way of a first sliding movement which runs along the sliding axis 190. Purely by way of example, the sliding axis 190 runs parallel to the movement axis 195. The second sliding ring 175 can be brought onto the second base ring 171 by way of a second sliding movement which runs along the sliding axis 190 and is aligned opposite to the first sliding movement.

Preferably, a bypass opening 118 is formed in the first end cap 114 and/or in the second end cap 115, said bypass opening on the one hand running out into the working recess, thus into the first pressure chamber 124 or second pressure chamber 125 and on the other hand into the respective fluid connection 117. In particular, a bypass opening 118 is formed in the first end cap 114 and in the second end cap 115. The working recess can be pressurised and/or vented in a permanently manner via the bypass openings 118, which is to say independently of whether the venting device 160 is situated in the first venting position 180 or in the second venting position 182.

FIG. 3 shows a detail of the venting device 160 which is situated in a first venting position 180, in a sectioned view. With regard to the representation which is shown in FIG. 4, the venting device is situated outside the first venting position 180. With regard to the details which are shown in FIGS. 3 and 4, only the first base ring 161 and the first sliding ring 165 are visible. All that which is stated hereinafter with regard to the first base ring 161 and the first sliding ring 165 in particular applies in the same manner to the second base ring 171 and the second sliding ring 175.

The first base ring 161 comprises a first base surface 162 which faces the first sliding ring 165. The first sliding ring 165 comprises a first sliding surface 166 which faces the first base ring 161. Purely by way of example, the first sliding surface 166 faces inwards and the first base surface 162 faces outwards, so that the first sliding ring 165 encloses the first base ring 161 from the outside. Alternatively, the first base ring 161 and the first sliding ring 165 can be designed in a manner such that the first base ring 161 encloses the first sliding ring 165 from the outside.

The first base ring 161 comprises a first base venting section 163 on the first base surface 162. The first sliding ring 165 comprises a first sliding venting section 167 on the first sliding surface 166. Purely by way of example, the first base venting section 163 and the first sliding venting section 167 are each deepened. The venting device 160 is moved into the first venting position 180 when the actuator element 120 is moved into the first damping section 130 (cf. FIG. 2). In the first venting position 180, the first base venting section 163 and the first sliding venting section 167 at least partly overlap one another. When the actuator element 120 is moved into the second damping section 132 (cf. FIG. 2) the venting device 160 is moved into a second venting position 182 in which a second base venting section 173 of the second base ring 171 which is arranged on a second base surface 172 of the second base ring 171 and a second sliding venting section 177 of the second sliding ring 175 which is arranged on a second sliding surface 176 of the second sliding ring 175 at least partly overlap one another.

The venting device 160 is configured to vent the working recess, in particular the second pressure chamber 125 when the actuator element 120 is situated in the first damping section 130. Purely by way of example, this is achieved by way of working fluid being able to exit from the second pressure chamber 125 via the first base venting section 163 and the first sliding venting section 167 via the first end cap 114 and the fluid connection 117 of the first end cap 114 into an environment which surrounds the pneumatic actuator 110, in particular via the second fluid conduit 232.

The venting device 160 is further configured to vent the working recess, in particular the first pressure chamber 124 when the actuator element 120 is situated in the second damping section 132. Purely by way of example, this is achieved by way of working fluid being able to exit out of the first pressure chamber 124 via the second base venting section 173 and the second sliding venting section 177 via the second end cap 115 and the fluid connection 117 of the second end cap 115 into the environment which surrounds the pneumatic actuator 110, in particular via the first fluid conduit 231. A venting into the environment can herein also comprise or be a feeding-back of working fluid out of the first pressure chamber 124 and/or the second pressure chamber 125 into a fluidic system which is formed by the valve terminal 200.

The first base ring 161 comprises a radially circumferentially closed first base sealing section 164 on the first base surface 162. The first sliding ring 165 comprises a radially circumferentially closed first sliding sealing section 168 on the first sliding surface 166. On account of the first base sealing section 165 and the first sliding sealing section 168 one succeeds in working fluid not being able to pass through via the first base venting section 163 and/or via the first sliding venting section 163 when first base ring 161 and the first sliding 165 merely overlap in the region of the first base sealing section 164 and/or of the first sliding sealing section 168.

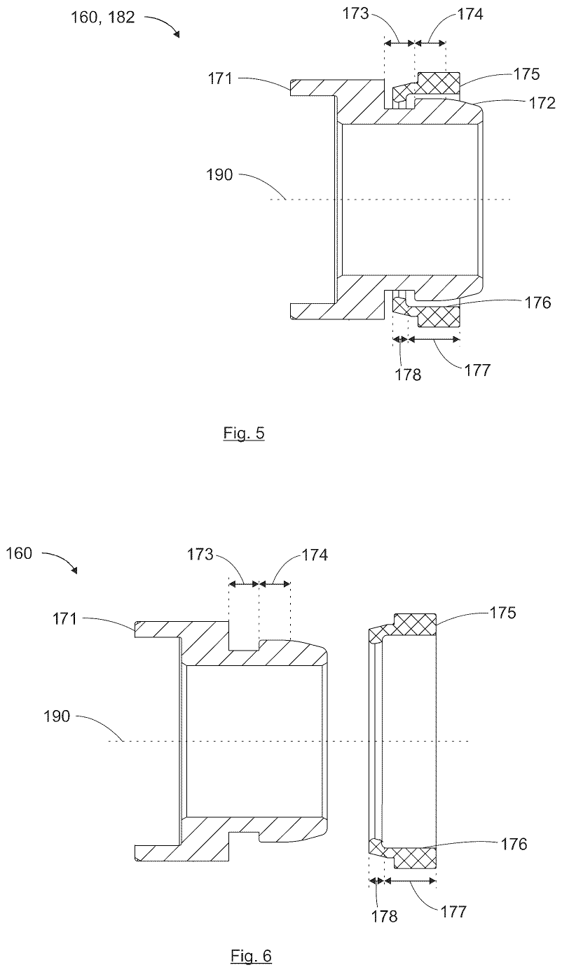

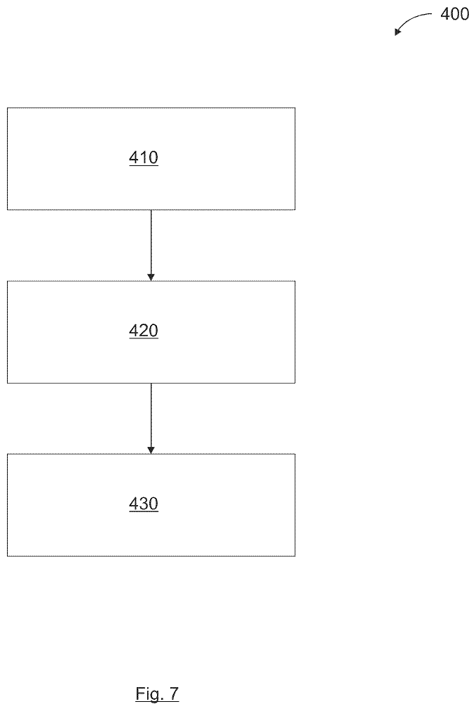

FIG. 5 shows a further detail of the venting device 10 in the second venting positing 182 and FIG. 6 the detail of the venting device 160 represented in FIG. 5, outside the second venting position 182. With regard to the details of the venting device 160 which are represented in FIGS. 5 and 6, the second base ring 171 and the second sliding ring 175 are represented. Purely by way of example, the first base ring 161 and the second base ring 171 are designed in the same manner and the first sliding ring 165 and the second sliding ring 175 are designed in the same manner. All which has been stated above with regard to the first base ring 161 applies in the same manner to the second base ring 171 and all which has been stated above with regard to the first sliding ring 165 applies in the same manner to the second sliding ring 175.

That which has been stated above with regard to the first base surface 162 applies in the same manner to the second base surface 172. That which has been stated above with regard to the first base venting section 163 applies in the same manner to the second base venting section 173. That which has been stated above with regard to the first sliding surface 166 applies in the same manner to the second sliding surface 176. That which has been stated above with regard to the first sliding venting section 167 applies in the same manner to the second sliding venting section 177. The second base ring 171 on the second base surface 172 comprises a radially circumferentially closed second base sealing section 174, regarding which that which has been stated above concerning the first base sealing section 164 applies in the same manner. The second sliding ring 175 on the second sliding surface 176 comprises a radially circumferentially closed second sliding sealing section 178, regarding which that which has been stated above concerning the first sliding sealing section 168 applies in the same manner.

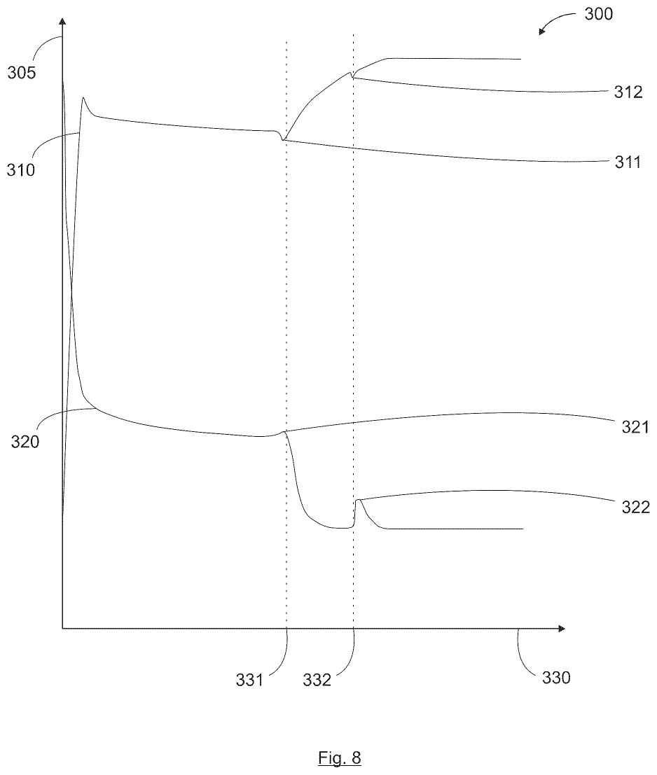

FIG. 7 shows a method 400 for the detection of a position of the actuator element 120 amid the use of the detection device 220. The method 400 comprises the following steps 410, 420, 430. In a first step 410a. the pneumatic actuator 110 is provided in the main movement section 135. In a second step 420 b. the working recess is subjected to working fluid, in order to move the actuator element 120 into the first damping section 130 and to vent the working recess, wherein a primary pressure signal 310 is detected during the movement by way of the first pressure sensor 222. In a third step 430 c. a first primary pressure extreme 311 of the primary pressure signal 31 and/or a second primary pressure extreme 312 of the primary pressure signal 310 is determined by way of the control unit 221, wherein as a response to the first primary pressure extreme 311 being acquired, it is detected by way of the control unit 221 that the actuator element 120 has entered into the first damping section 130, and/or wherein as a response to the second primary pressure extreme 312 being acquired, it is detected by way of the control unit 221 that the actuator element 120 has reached the first position 131.

Purely by way of example, a secondary pressure signal 320 is detected by the second pressure sensor 233 during the movement of the actuator element 120. A first secondary pressure extreme 321 of the secondary pressure signal 320 and/or a second secondary pressure extreme 322 of the secondary pressure signal 320 is determined by way of the control unit 221, wherein as a response to the first secondary pressure extreme 321 being acquired, it is detected by way of the control unit 221 that the actuator element 120 has entered into the first damping section 130, and/or as a response to the second secondary pressure extreme 32 being acquired, it is detected by way of the control unit 221 that the actuator element 120 has reached the first position 131.

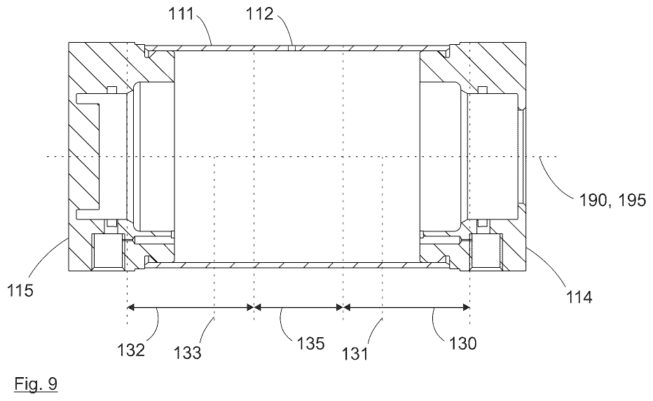

FIG. 8 shows a diagram 300. A temporal course of the primary pressure signal 310 and of the secondary pressure signal 320 is plotted on a pressure axis 305 over a time axis 330. Purely by way of example, the first primary pressure extreme 311 and the second primary pressure extreme 312 are each formed as a minimum. Further by way of example, the first secondary pressure extreme 321 and the second secondary pressure extreme 322 are each formed as a maximum. The first primary pressure extreme 311 and the first secondary pressure extreme 321 each occur at a first point in time 331. The second primary pressure extreme 312 and the second secondary pressure extreme 322 each occur at a second point in time 332.

Purely by way of example, the second point in time 332 corresponds to the point in time at which the actuator element 120 reaches the first position 131. If the actuator element 120 coming from the main movement section 135 were to be moved into the second damping section 132, then the first primary pressure extreme 311 and the second primary pressure extreme 312 would each be formed as a maximum and the first secondary pressure extreme 321 and the second secondary pressure extreme 322 would each be formed as a minimum.

FIG. 9 shows a further actuator housing 111 of the pneumatic actuator 110 which is represented in FIG. 2. In contrast to the actuator housing 111 which is represented in FIG. 2, the actuator housing 111 which is represented in FIG. 9 comprises an intermediate venting opening 112. The intermediate venting opening 112 is arranged in the main movement section 135. The venting device 160 is configured to partially vent the working recess when the actuator element 120 is situated in the region of the intermediate venting opening 112 (cf. also FIG. 2).

1. A method for the detection of a position of an actuator element of a pneumatic actuator amid the use of a detection device with a control unit and with a first pressure sensor, wherein the pneumatic actuator comprises a venting device and an actuator housing in which a working recess with a first pressure chamber is formed, wherein the actuator element is received in the working recess and by way of the subjection of the working recess to working fluid is movable in the working recess from a main movement section of the working recess through a first damping section of the working recess which is arranged adjacently to the main movement section, towards a first position, wherein the venting device is configured to vent the working recess when the actuator element is situated in the first damping section, wherein the first pressure sensor is assigned to the first pressure chamber, wherein the method comprises the following steps:
providing the pneumatic actuator in the main movement section,
subjecting the working recess to working fluid, in order to move the actuator element into the first damping section and to vent the working recess, wherein a primary pressure signal is detected by a first pressure sensor during the movement, and
determining a first primary pressure extreme of the primary pressure signal and/or a second primary pressure extreme of the primary pressure signal by way of the control unit, wherein as a response to the first primary pressure extreme being acquired, it is detected by way of the control unit that the actuator element has entered into the first damping section, and/or wherein as a response to the second primary pressure extreme being acquired, it is detected by way of the control unit that the actuator element has reached the first position.

2. The method according to claim 1, wherein the first pressure chamber is subjected to working fluid, in order to move the actuator element into the first damping section.

3. The method according to claim 2, wherein the first primary pressure extreme is a minimum and/or the second primary pressure extreme is a minimum.

4. The method according to claim 1, wherein the working recess comprises a second pressure chamber which is fluidically separated from the first pressure chamber by way of the actuator element, wherein the detection device comprises a second pressure sensor which is assigned to the second pressure chamber, wherein a secondary pressure signal is detected by the second pressure sensor during the movement of the actuator element, wherein a first secondary pressure extreme of the secondary pressure signal and/or a second secondary pressure extreme of the secondary pressure signal is determined by way of the control unit, wherein as a response to the first secondary pressure extreme being acquired, it is detected by way of the control unit that the actuator element has entered into the first damping section and/or wherein as a response to the second secondary pressure extreme being acquired, it is detected by way of the control unit that the actuator element has reached the first position.

5. The method according to claim 4, wherein the first secondary pressure extreme is a maximum and/or the second secondary pressure extreme is a maximum.

6. The method according to claim 1, wherein a second damping section is arranged in the working recess adjacently to the main movement section and in a manner lying opposite to the first damping section, wherein the venting device is configured to vent the working recess when the actuator element is situated in the second damping section, wherein the actuator element is movable from the main movement section through the second damping section towards a second position, wherein the working recess is subjected to working fluid, in order to move the actuator element into the second damping section and to vent the working recess.

7. The method according to claim 1, wherein the primary pressure signal and/or the secondary pressure signal is detected at a frequency of up to between 500 Hz and 16,000 Hz.

8. The method according to claim 1, wherein on detection by way of the control unit that the actuator element has reached the first position, one uses an artificial intelligence model.

9. A system of a pneumatic actuator and a detection device, wherein the pneumatic actuator comprises a venting device and an actuator housing, wherein a working recess with a first pressure chamber is formed in the actuator housing, wherein an actuator element is received in the working recess and by way of the subjection of the working recess to working fluid is movable in the working recess from a main movement section of the working recess through a first damping section of the working recess which is arranged adjacently to the main movement section, towards a first position, wherein the venting device is configured to vent the working recess when the actuator element is situated in the first damping section, wherein the detection device comprises a control unit and a first pressure sensor, wherein the first pressure sensor is assigned to the first pressure chamber, wherein the system is configured to carry out a method according to claim 1.

10. The system according to claim 9, wherein the venting device comprises a first base ring and a first sliding ring, wherein the first base ring or the first sliding ring is fixed to the actuator element, wherein the first sliding ring can be brought onto the first base ring by way of a first sliding movement which runs along a sliding axis, so that a first sliding surface of the first sliding ring which faces the first base ring at least partly covers a first base surface of the first base ring which faces the fist sliding ring, wherein the first base ring comprises a first base venting section on the first base surface, wherein the first sliding ring comprises a first sliding venting section on the first sliding surface, wherein the first base venting section and/or the first sliding venting section are deepened, wherein when the actuator element is moved into the first damping section, the venting device is moved into a first venting position in which the first base venting section and the first sliding venting section at least partly overlap one another.

11. The system according to claim 9, wherein a second damping section is arranged in the working recess adjacently to the main movement section and in a manner lying opposite to the first damping section, wherein the actuator element is movable from the main movement section through the second damping section towards a second position, wherein the working recess can be subjected to working fluid in order to move the actuator element into the second damping section and to vent the working recess, wherein the venting device comprises a second base ring and a second sliding ring, wherein the second base ring or the second sliding ring is fixed to the actuator element, wherein the second sliding ring can be brought onto the second base ring by way of a second sliding movement which runs along the sliding axis and is directed opposite to the first sliding movement, so that a second sliding surface of the second sliding ring which faces the second base ring at least partly covers a second base surface of the second base ring which faces the second sliding ring, wherein the second base ring comprises a second base venting section on the second base surface, wherein the second sliding ring comprises a second sliding venting section on the second sliding surface, wherein the second base venting section and/or the second sliding venting section are deepened, wherein when the actuator element is moved into the second damping section, the venting device is moved into a second venting position in which the second base venting section and the second sliding venting section at least partly overlap one another.

12. The system according to claim 9, wherein the first base ring comprises a radially circumferentially closed first base sealing section on the first base surface and/or the first sliding ring comprises a radially circumferentially closed first sliding sealing section on the first sliding surface.

13. The system according to claim 9, wherein the detection device is distanced to the pneumatic actuator, preferably at a distance of at least 10 cm.

14. The system according to claim 9, wherein the actuator housing comprises an intermediate venting opening which is arranged in the main movement section, wherein the venting device is configured to partially vent the working recess when the actuator element is situated in the region of the intermediate venting opening.

15. The system according to claim 9, further comprising a valve terminal with several pneumatic valves, wherein the valve terminal in particular comprises the detection device, wherein at least one of the pneumatic valves is assigned to the pneumatic actuator, wherein the first pressure sensor is assigned to the pneumatic valve which is assigned to the pneumatic actuator.
